(19) United States
(12) Patent Application Publication
(10) Pub. No.: US 2023/0010577 A1
(43) Pub. Date: Jan. 12, 2023

(54) Computer-Based System for Locking User Account Access

(71) Applicant: Capital One Services, LLC, McLean, VA (US)

(72) Inventors: Tyler Maiman, Melville, NY (US); Abdelkader M'Hamed Benkreira, Brooklyn, NY (US); Brendan Way, Brooklyn, NY (US)

(73) Assignee: Capital One Services, LLC, McLean, VA (US)

(21) Appl. No.: 17/367,877

(22) Filed: Jul. 6, 2021

(51) Int. Cl. G06F 21/62; G06F 21/35; G06F 9/445

(52) U.S. Cl. CPC G06F 21/6209; G06F 21/35; G06F 9/44594

(57) ABSTRACT

A computing device may determine that a user of an application is asleep based on data of a wearable computing device that is associated with a user. Based on the determination that the user is asleep, the computing device may lock an account that is associated with the user. Locking the account may involve restricting actions that the user is permitted to take with respect to the application. The computing device may receive an indication of a first transaction that is associated with the account of the user. Based on the determination that the account is locked, the computing device may prohibit the transaction. The computing device may receive an indication that the user is awake. Based on the indication that the user is awake, the computing device may unlock the account and permit a second transaction.

### TECHNICAL FIELD

The present disclosure is generally related to enhancing the security of a user account.

### BACKGROUND

A computer-based system may be configured to execute an application that may have access to sensitive user data. However, malicious actors may attempt to take actions that may negatively impact the accounts and/or data of such legitimate users. Such actions may include: impersonating a user to gain access to a user's account, executing a fraudulent transaction that is associated with the user's account, etc.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding methods, apparatuses, systems, and computer-readable media are also within the scope of the disclosure.

Systems described herein provide a computing system that may be configured to execute an application. The application may be configured to access data, and/or to process transactions, such as financial transactions. A transaction may be associated with one or more users of the application. A user of the application may have an associated account. When the user is logged into the application, the user may take various actions via the application, such as generating transactions, etc. The computing system may be configured to determine whether one or more users of the application are asleep. The application may receive data from a wearable computing device, and based on the received data, may determine that the user is asleep and lock the user's account. Once a user's account has been locked, the computing system may restrict types of actions that may be performed with respect to the user's account. Locking the user's account stop malicious actors from completing malicious actions with respect to the user's account while the user is determined to be asleep.

### BRIEF DESCRIPTION OF THE DRAWINGS

The present disclosure is described by way of example and not limited in the accompanying figures in which like reference numerals indicate similar elements and in which:

FIG. 1 shows an example of an operating environment in which one or more aspects described herein may be implemented;

FIG. 2 shows an example computing device in accordance with one or more aspects described herein;

FIG. 3 shows an example flow chart of a process for locking a user's account in accordance with one or more aspects described herein;

FIG. 4 shows an example flow chart of a process for locking a user's account in accordance with one or more aspects described herein; and

FIG. 5 shows yet another example flow chart of a process for locking a user's account in accordance with one or more aspects described herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and for computer-based systems that are configured to execute an application may process transactions, such as financial transactions. The application may process payments that associated with users' financial accounts. Some examples of such accounts may comprise credit card, bank, and/or checking accounts. The application may authenticate a user if the user is able to verify to supply correct authentication information, such as a correct username and password, etc.

Once authenticated, a user of the application may be able to take various actions with respect to the user's accounts and/or the transactions associated therewith. For example, by using the application, an authenticated user may be able to initiate a transaction that may transfer money from one account to another. As another example, of user may be able to initiate credit card and/or checking account transactions, which may cause money to be withdrawn from, or deposited to, a user's account. Thus, these financial applications provide significant control over the financial resources that are associated with a user's account and their financial livelihood.

Because of the potential financial resources that may be obtained from gaining an access to a user's account, financial accounts are frequently the target of malicious actors. Malicious actors may perform various actions to attempt to illegally obtain money from a user's account. For example, malicious actors may attempt to perpetrate various forms of fraud, such as attempting to execute fraudulent account transactions from a user's account, and/or stealing a user's account credentials in order to obtain control of the money in a user's accounts.

If such a malicious actor were able to successfully gain access to a user's account via a financial application, the financial consequences for the legitimate user may be significant. For example, all the money in the user's financial account may be lost and transferred to another person's account. Accordingly, financial institutions employ many security techniques to mitigate various forms of malicious activity such as hacking, fraudulent transactions, etc.

Nevertheless, in spite of the best security efforts of financial institutions, malicious actions such as fraud and account hacking may still be successful. The techniques of this disclosure improve the security of a user's application account by locking down the user's accounts while a user is determined to be asleep.

Locking down a user's account may involve restricting the types of actions that may be performed with respect to a user's account. While a user's account is locked, certain transactions that are associated with the user may be prohibited. For instance, credit card transactions may be prohibited. Locking the user's account may involve prohibiting types of permissible accesses to the user's account, such as prohibiting customer support transactions or in-person credit card transactions, etc.

When a user is asleep, a legitimate user would seemingly be unable to perform any of these prohibited actions. So, anyone performing such prohibited actions while the user is asleep is likely a malicious actor. Consequently, the techniques of this disclosure may block malicious actions that may be performed with respect to a user's account while the user is asleep. Prohibiting these actions while the user is asleep may reduce the overall amount of successful malicious activity that may occur with respect to user accounts, and thereby improve application security all without imposing onerous additional requirements, such as difficult-to-remember passwords, etc.

Furthermore, techniques of this disclosure may reduce certain kinds of malicious activity that may be difficult to detect using existing account security techniques. For example, existing security techniques frequently fail to detect so-called “friendly fraud,” which is a fraud perpetrated by someone that an account holder knows, such as a friend or relative. For example, friendly fraud could occur if a first family member obtains a second family member's credit card while the second family member is asleep and makes credit card transactions without the sleeping family member's permission. This difficult-to-detect friendly fraud would be largely deterred if credit card transactions were prohibited while the second family member is determined to be asleep.

### Operating Environments and Computing Devices

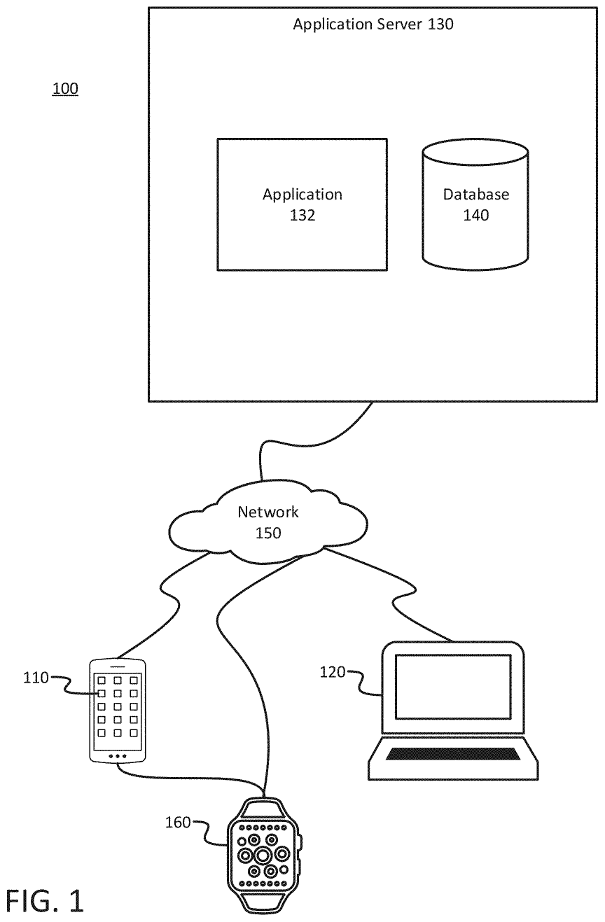

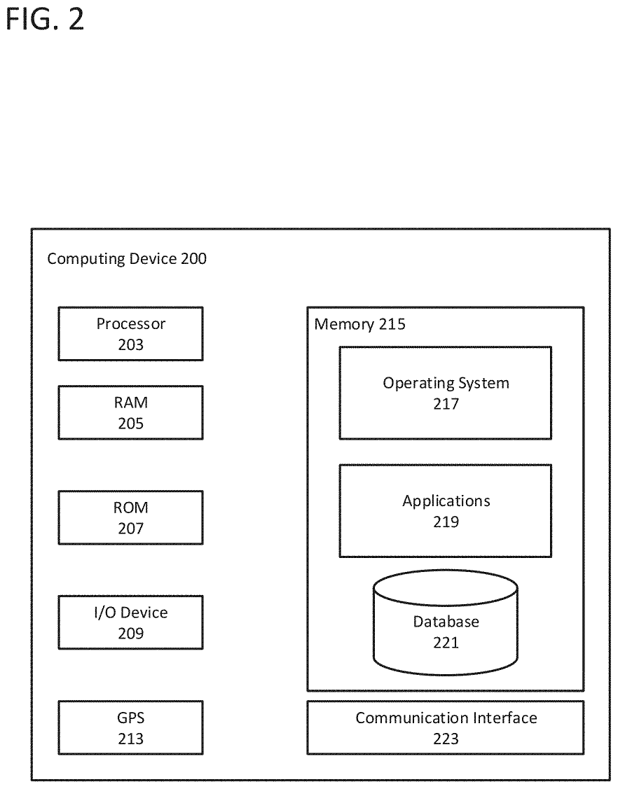

FIG. 1 shows an operating environment 100. The operating environment 100 may include at least user client device 110, client device 120, application server 130, and wearable device 160 in communication via a network 150. It will be appreciated that the network connections shown in relation to network 150 are illustrative and any means of establishing a communications link between the computers may be used. The existence of any of various network protocols such as TCP/IP, Ethernet, FTP, HTTP and the like, and of various wireless communication technologies such as Bluetooth, GSM, CDMA, 3GPP protocols, WiFi, LTE, and/or 5G, is presumed, and the various computing devices described herein may be configured to communicate using any of these network protocols or technologies. Any of the devices and systems described herein may be implemented, in whole or in part, using one or more computing systems described with respect to FIG. 2.

Client devices 110, 120, and/or wearable device 160 may execute, provide data to, and/or interact with the applications described herein. Examples of client devices 110, 120 may comprise computing devices, such as smartphones, tablets, laptops, wearable devices, or various other forms of computing devices as well. Access to application server 130 or resources thereof may be restricted to certain ones of client devices 110, 120 such as client devices that provide certain credentials for authenticating users of those client devices.

Wearable device 160 may comprise any of a number of different devices, such as a fitness tracker, smart watch, smart ring, smart glasses, etc. Wearable device 160 may be equipped with one or more sensors that may be configured to monitor physical properties, some of which may be associated with a user of the wearable device. These sensors may include gyroscopes, accelerometers, optical sensors, etc. Wearable device 160 may also be configured to monitor biometric data, such as a user's pulse, blood pressure, eye movement, fingerprint, blood glucose, blood oxygen, etc. In some examples, wearable device 160 may monitor movements of a user, such as whether the user is walking, lying down, etc.

Based on the data obtained from wearable device 160, a computing device may determine whether the user is asleep. For instance, wearable device 160 itself may determine that a user who is wearing the device is asleep. This determination may be made for example based on movement data obtained by the device. In some examples, a client device, such as client device 110 or 120, may receive such movement data from wearable device 160. Based on the received data, the client device may determine whether the user is asleep. In some examples, application server 130 may receive data, either directly or indirectly (e.g. via client device 110 or 120) from wearable device 160, and may determine whether the user is asleep based on the data received. It should be further understood that any combination of wearable device 160, client devices 110, 120, and/or application server 130 may determine whether the user is asleep.

Application server 130 may comprise one or more devices, which may include processors and/or memory, that may be configured to execute a variety of different applications and/or components that may employ the financial security techniques of this disclosure. Application server 130 may comprise components and/or associated applications such as application 132, and/or database 140.

Application 132 may execute on application server 130. Application 132 may comprise a web application, mobile application, or any other type of application. While application 132 is illustrated as executing on application server 130, it should be understood that application 132 may partially execute on application server 130, and/or on client devices 110, 120. For example, application 132 may comprise a web application that may be rendered by a web browser executing on client devices 110, 120. In this manner, application 132 may deliver a web-based payload to client devices 110, 120.

If application 132 partially executes on a client device, application 132 application may receive data from a component of application 132 executing on application server 130, such as a back-end component. As another example, application 132 may be a standalone application that does not communicate with application server 130. Application 132 may be distributed, and/or execute on other devices as well. According to various examples, application 132 may comprise a desktop application, mobile application, web application, or a combination thereof. In some examples, application 132 may be configured as a browser extension that may execute in conjunction with a web browser. Such a web browser may in turn execute on client devices 110 or 120. Application 132 may take various other forms as well.

Application server 130 may execute database 140, which may be an in-memory database that may offer faster database reads and writes as compared to databases that are not in-memory. Examples of such databases may include, but are not limited to: relational databases, hierarchical databases, distributed databases, in-memory databases, flat file databases, XML, databases, NoSQL databases, graph databases, and/or a combination thereof.

Database 140 may store data associated with one or more users of application 132. Such stored data may comprise information that may be used to authenticate users, such as usernames and passwords, user profile information, and/or application data. As an example, application 132 may comprise a financial application. Authentication information for the user, such as information for validating a user's username and password may be stored in database 140. Additionally or alternatively, application data related to the user, such as a user's financial accounts, account balances, recent transactions, credit score data, fraud monitoring data, etc., may be stored in database 140. In some examples, such user profile information may comprise sleep data that may indicate whether a user is currently asleep, and/or historical sleep data associated with the user. Such sleep data may be based on data such as movement data that may have originated from wearable device 160.

Application 132 may utilize such sleep when performing the financial security techniques described herein. As described in greater detail below, application 132 may use such sleep data to determine whether a user is asleep. Based on the determination that the user is asleep, application 132 may lock a user's account of the application. Locking the application may involve prohibiting one or more types of actions that may be performed with respect to the user's account. While such sleep data is described as being stored within database 140, it should be understood that such preferences may be stored locally, for example on client devices 110, 120, as well.

Various computing devices are described as performing functions described in the context of operating environment 100. However, it should be noted that any computing device or combination of computing devices in the operating environment 100 may perform any of the processes and/or store any data as described herein

The data transferred to and from various computing devices in operating environment 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in data transfers to protect the integrity of the data such as, but not limited to, Secure File Transfer Protocol (SFTP), and/or Pretty Good Privacy (PGP) encryption. In many embodiments, one or more web services may be implemented within the various computing devices of operating environment 100. Web services may be accessed by authorized external devices and users to support input, extraction, and manipulation of data between the various computing devices in the operating environment 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in the operating environment 100 in front of one or more computing devices such that any external devices may communicate directly with the specialized hardware.

Turning now to FIG. 2, a conceptual illustration of a computing device 200 that may be used to perform any of the techniques as described herein is shown. The computing device 200 may include a processor 203 for controlling overall operation of the computing device 200 and its associated components, including RAM 205, ROM 207, input/output device 209, communication interface 223, and/or memory 215. A data bus may interconnect processor(s) 203, RAM 205, ROM 207, memory 215, I/O device 209, and/or communication interface 223. In some embodiments, computing device 200 may represent, be incorporated in, and/or include various devices such as a desktop computer, a computer server, a mobile device, such as a laptop computer, a tablet computer, a smart phone, any other types of mobile computing devices, wearable device, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203 allowing computing device 200 to perform various actions. Memory 215 may store software used by the computing device 200, such as an operating system 217, applications 219, and/or an associated internal database 221. The various hardware memory units in memory 215 may include volatile and/or nonvolatile, removable and/or non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Communication interface 223 may include one or more transceivers, digital signal processors, and/or additional circuitry and software for communicating via any network, wired or wireless, using any protocol as described herein. It will be appreciated that the network connections shown are illustrative and any means of establishing a communications link between the computers may be used. The existence of any of various network protocols such as TCP/IP, Ethernet, FTP, HTTP/S, TLS, and the like, and of various wireless communication technologies such as GSM, CDMA, WiFi, LTE, and/or 5G is presumed, and the various computing devices described herein may be configured to communicate using any of these network protocols or technologies.

Processor 203 may include a single central processing unit (CPU), which may be a single-core or multi-core processor, or may include multiple CPUs, which may have a single core or multiple cores. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches including, but not limited to, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the invention.

### Example Security Flows

As discussed herein, application 132 may be configured to determine whether a user asleep, and if the user is determined to be asleep, may lock the user's account which may involve prohibiting certain actions that may be taken with respect to the user's account while the user is asleep.

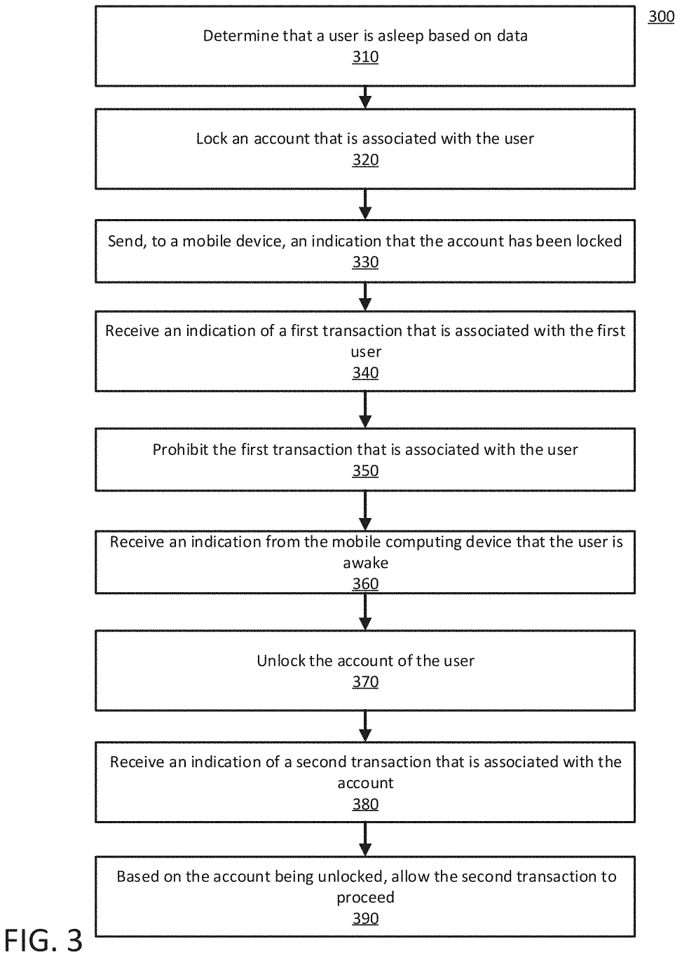

FIG. 3 shows an example flow chart of such a process 300 for locking a user's account based on determining that the user is asleep. Some or all of the steps of process 300 may be performed using one or more computing devices as described herein. In a variety of embodiments, some or all of the steps described below may be combined and/or divided into sub-steps as appropriate.

At step 310, a first computing device (e.g., application 132 executing on application server 130) may receive an indication that a user is asleep. The user may be determined to be asleep based on various data. As examples, client device 110 or wearable device 160 may determine that a user is asleep based on various forms of data related to a user's movement and/or biology. The movement and/or biology data may comprise accelerometer data, eye tracking data, blood pressure data, bloody oxygen data, blood sugar data, device activity (e.g., whether the user is actively using the device), brain wave data, electrocardiogram (ECG) data, etc. Client device and/or 110 wearable device 160 may determine that a user is asleep based on the movement and/or biologic data using various techniques and/or heuristics as well. Some examples of these techniques may comprise determining that a user has not moved a sufficient amount (e.g., more than a minimum threshold amount) in a given time period, determining that a user has a pulse rate below a threshold rate, etc. According to yet further examples, the computing device may determine that a user is asleep based on a user's computing device being in a “Do not Disturb” (DnD) mode.

At step 320, the computing device may lock an account that is associated with the user. Locking the account that is associated with the user may comprise restricting actions that may be taken with respect to one or more accounts that are associated with the user. As one example, all financial transactions may be blocked while the user is asleep. Alternatively, only some types of transactions may be prohibited while the user is determined to be asleep. For example, if the user has a credit card account and a checking account, in-person credit card account charges and physical checking transactions may be prohibited while the user is determined to be asleep. Wire transfers may also be blocked while the user is determined to be asleep. Because in-person credit card transactions and transactions involving physical checks cannot ordinarily occur while a user is asleep, prohibiting such transactions may improve user account security by blocking fraudulent charge and checking transaction attempts.

Customer support transactions may be prohibited while the user is determined to be asleep. Certain types of support transactions, such as phone call support transactions, chat transactions, etc., that ordinarily require the user to be awake, may be prohibited according to some examples. Prohibiting customer support transactions may prevent customer support fraud in which a malicious actor attempts to impersonate the user to a customer support representative or system and thereby gain access to a user's account, e.g., by changing the user's password to a value known by the malicious actor.

Certain types of transactions may be permitted while the user is asleep. For example, recurring transactions such as bills, payments involving an authorized or joint account holder (such as a partner, etc.), already-posted transactions, and/or card-not-present transactions (e.g., recurring credit card transactions that do not require a credit card to be present to complete) may be permitted while the user is asleep.

At step 330, and based on locking the user's account, the computing device (e.g., application server 130) may send an indication that the user's account has been locked. The indication may be sent to a computing device (e.g., a mobile device) associated with the user, such as client device 110, as one example. The indication may cause the mobile device to display a notification that the user's account has been locked. Such a notification may be displayed in a notification center, and/or in an application associated with the user's financial account(s), as some examples. In some instances, indication may cause the appearance of the application to change in order to indicate the account being locked.

At step 340, the computing device may receive an indication of a first transaction that is associated with the user. The first transaction may take various forms, such as a financial transaction, customer support transaction, financial account login attempt, etc. In some examples, the computing device may form part of a financial processing network, and may receive indications of financial transactions via the processing network. In various examples, the computing device may receive an indication of customer support requests via a customer support network with which the computing device may be communicatively coupled. Such transactions may take various other forms and may be received in various other manners as well.

At step 350 and based on the user's account being locked, the computing device may prohibit the first transaction that is associated with the first user. The computing device may prohibit the transaction based on the type of transaction according to some examples. For instance, for a card-present credit card transaction, a checking transaction involving a physical check, or a wire transfer, any of these financial transaction types may be prohibited. If the transaction is a customer support transaction, the computing device may prohibit the customer support transaction if a user, who is determined to be asleep, is supposedly present during the support transaction. For example, chat-based and phone-based customer support transactions may be prohibited while the user is determined to be asleep.

At step 360, the computing device may receive an indication, from the mobile computing device, that the user is awake. The indication that the user is awake may be received based on various conditions. As an example, the user may indicate that he or she is awake by providing a user input. In some examples, an application may prompt a user to provide input “proving” that the user is awake. For example, the application may prompt a user to provide biometric proof that the user is awake (e.g., a face scan fingerprint, etc.), and/or to perform an action, such as moving a computing device (e.g., shaking wearable device 160 or client device 110), or walking a given number of steps, etc. In some examples, the mobile computing device may automatically determine that the user is awake and send a notification indicating the same. For example, if the user logs into a phone or wearable device (e.g., by providing a passcode or providing biometric verification), is determined to be walking, or disables a DnD mode of a computing device belonging to the user, the mobile computing device may send an indication that the user is awake to the computing device (e.g., application server 130).

At step 370 (e.g., based on the indication that the user is awake), the application may unlock the account of the user. Unlocking the account of the user may permit one or more types of transactions, which were previously prohibited, to proceed if they occur.

At step 380, the computing device may receive an indication of a second transaction that is associated with the account of the user. The second transaction may be the same type as, or a different type than the first transaction of step 340.

At step 390 and based on the account being unlocked, the computing device may allow the second transaction to proceed. For example, if the second transaction is a card-present transaction and if the user's account is unlocked, the computing device may allow the card-present transaction to proceed.

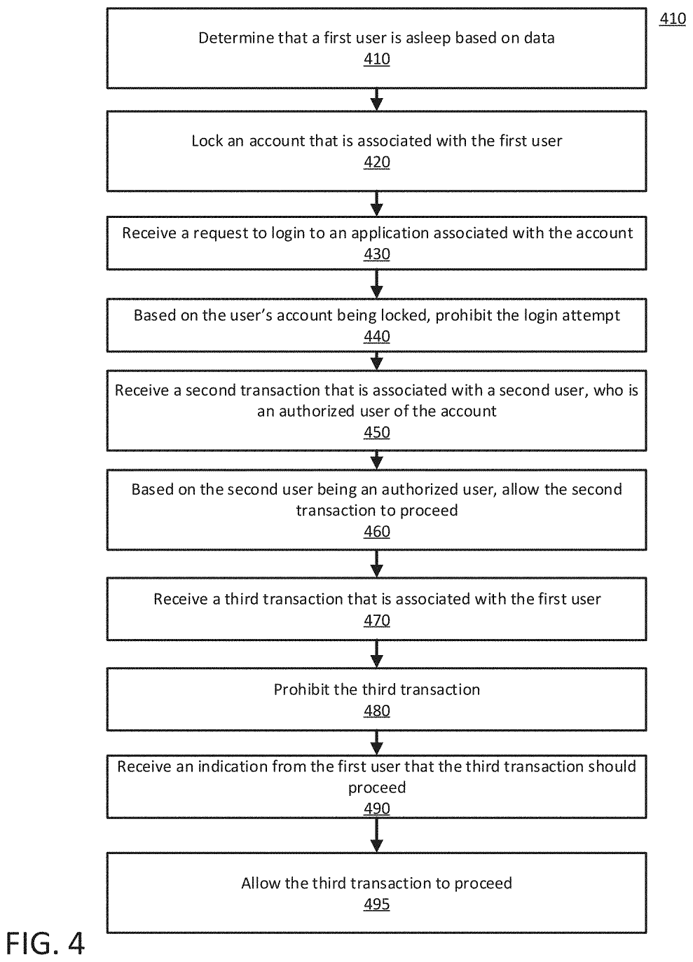

In some examples the security techniques of this disclosure may be applied to multiple users. FIG. 4 shows a flow chart of a process 400 for performing these security techniques with respect to multiple users.

Process 400 may begin at step 410. At step 410, a computing device (e.g., application 132 executing on application server 130) may receive an indication that a first user is asleep. The user may be determined to be asleep based on various data, such as the data described above, for instance in the context of step 310 of FIG. 3. In some examples, the data used to determine whether the user is asleep may be used to determine a level of confidence that the user is asleep. For instance, if a user has put a phone into DnD mode and a wearable device has not captured significant body movements, the computing device may determine a high confidence level that the user is sleeping. As another example, if the user has put a phone into DnD mode but the user has taken several steps, the computing device may determine that there is a low level of confidence that the user is asleep. If the confidence level exceeds a threshold value, such as 75% in one example, the computing device may determine that the user is asleep.

At step 420, the computing device may lock an account that is associated with the first user. Locking the account that is associated with the user may generally involve restricting or prohibiting actions that may be taken with respect to one or more accounts that are associated with the first user. Example actions that may be prohibited may comprise actions such as the actions described above with respect to step 320 of FIG. 3, as just some non-limiting examples.

At step 430, the computing device may receive a request to login to an application associated with the account. Such an application may comprise a financial application or another type of application. The request may specify, for example, a username and password, multi-factor authentication, etc.

At step 440, and based on the first user's account being locked, the computing device may prohibit the attempt to login to the application. In some instances, based on receiving the login attempt, the computing device may send a message to a computing device associated with the first user, indicating the prohibited login attempt. The message may indicate additional information associated with the prohibited login attempt, such as an IP address, web browser, operating system, etc., which the first user may review.

At step 450, the computing device may receive an indication of a second transaction that is associated with a second user who is an authorized user of the account. As examples, the second user may be a spouse, child, or another person who has joint rights to the account of the first user, etc. The second transaction may be, for example, a checking transaction, wire transfer, or card-present transaction, as some examples.

At step 460 (e.g., based on the second user being an authorized user), the computing device may allow the second transaction to proceed. For example, the computing device may receive an indication of a card-present transaction that is associated with the second user, and which is associated with the locked account. Despite the account being locked, the computing device may allow the card-present transaction to proceed.

At step 470, the computing device may receive a third transaction that is associated with the first user. The third transaction may be a transaction that may require the user to be awake for the transaction to proceed. For example, the third transaction may comprise a checking transaction that may involve a physical check. The third transaction may not be associated with a joint account holder of the account.

At step 480 (e.g., based on the first user's account being locked), the computing device may prohibit the third transaction. Based on prohibiting the third transaction, the computing device may send a message to a mobile computing device of the user, such as client device 110, 120, and/or wearable device 160. The message may indicate information related to the prohibited, third transaction, such as the transaction amount, time the transaction was placed, etc. In some examples, the message may include information associated with the purchaser. For example, if the message may indicate the purchaser's IP address and/or geodata. As another example, if a transaction is prohibited due to the user's account being locked, the application may request that the person initiating the transaction provide a voice sample. This voice sample may be provided as part of the message indicating the prohibited transaction. In this manner, a user receiving the message indicating the prohibited transaction may review the associated information, and based on the information, may determine whether the transaction should have been prohibited.

At step 490, the computing device may receive an indication that the third transaction should proceed. As an example, the indication that the transaction should be proceed may be based on user input from a mobile computing device associated with the first user. Such a user may provide such user input indicating that a previously-prohibited transaction proceed, if the user determines that the transaction should have been permitted. In some examples, this indication that the transaction should be allowed to proceed may take the form of a passcode or other authentication information, proof that the user is awake (e.g., as discussed in the context of step 360 above), etc.

At step 495 and based on receiving the indication that the third transaction should be allowed to proceed, the computing device may allow the third transaction to proceed. Additionally, the indication that that the third transaction to proceed may cause the computing device to unlock the account associated with the first user.

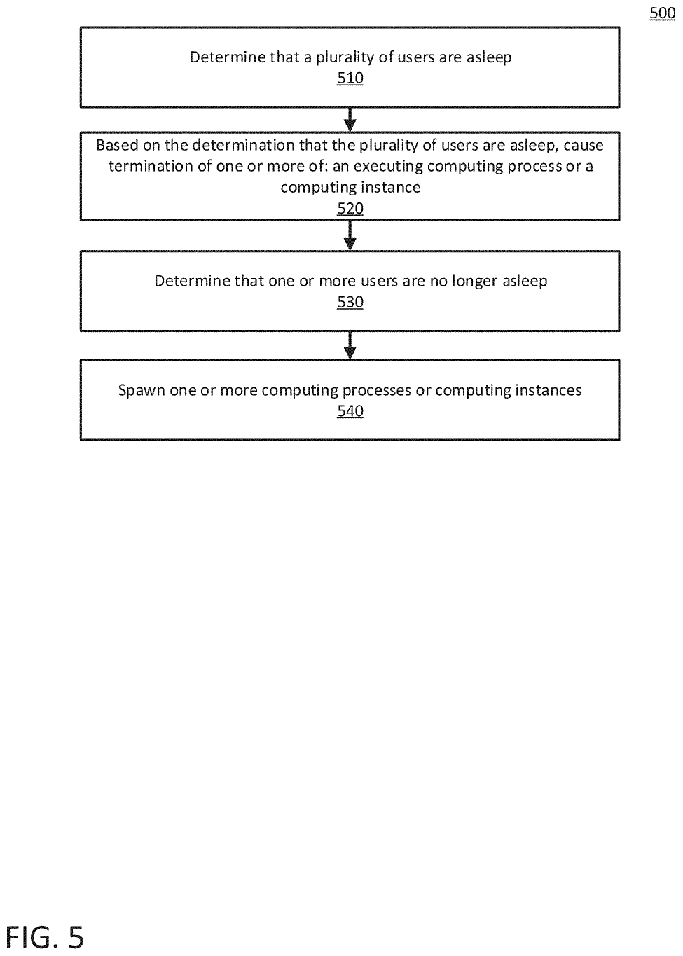

In some examples the security techniques of this disclosure be applied to multiple users, and may be used to manage the resource allocation and/or resource consumption of an associated computing system. FIG. 5 shows a flow chart of a process 500 for performing these security techniques, which may be further used to manage computing resources.

Process 500 may begin at step 510. At step 510, a computing device (e.g., application 132 executing on application server 130) may receive determine that a plurality of users are asleep. The plurality of users may all be users of a same application, such as a same financial application, etc. The computing device may determine that the plurality of users are asleep based on various data, such as movement data. The movement data for each user may be received from one or more corresponding computing devices. Additionally or alternatively, the plurality of users may be determined to be asleep based on historical sleep data. For instance, the computing device may access stored historical sleep data for the plurality of users. Based on the historical sleep data, the computing device may determine that some or all of the plurality of users have frequently gone to sleep at a given time.

At step 520, the computing device may cause termination of one or more of an executing computing process or a computing instance that may be associated with the application. As described above, the plurality of users may be associated with the same application, such as a financial application. This application may perform may perform various functions, such as transaction processing, as just one example. This application may be configured to execute in a distributed manner. For instance, the application may spawn multiple computing processes (e.g., threads, etc.), and/or multiple computing instances (e.g., physical machines, virtual machines, etc.) that may control the execution of the application. In some examples, the number of executing threads and/or computing instances may scale based on some function of load on the application (e.g., number of transactions being processed per time, number of active users, etc.). When many users are asleep, these parameters application load parameters may decrease. Accordingly, the computing device may cause termination of computing resources that are associated with the application, such as processes, computing instances, etc.

At step 530, the computing device may determine that one or more users are no longer asleep. The computing device may determine that the users are awake based on current movement data, historical sleep data, etc.

At step 540 (e.g., based on the determination that the one or more users are no longer asleep), the computing device may spawn one or more: computing processes (e.g., threads, etc.), or computing instances. The newly-spawned computing resources and processes may be allocated to the application in order to handle the load resulting from additional users who are determined to be awake and who are using or are predicted to be using the application.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML, or XML. The computer-executable instructions may be stored on a computer-readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

What is claimed is:

1. A computer-implemented method comprising:
receiving, by a computing device and from a mobile computing device, an indication that a user is asleep, wherein the indication that the user is asleep is based on movement data of a wearable computing device that is associated with the user;
locking, based on the indication that the user is asleep, an account that is associated with the user, wherein locking the account comprises restricting allowable actions that are associated with the account;
receiving an indication of a first transaction that is associated with the account of the user;
prohibiting, based on the account being locked, the first transaction;
receiving, from the mobile computing device, an indication that the user is awake;
unlocking, based on the indication that the user is awake, the account of the user;
receiving an indication of a second transaction that is associated with the account; and
allowing, based on the account being unlocked, the second transaction to proceed.

2. The computer-implemented method of claim 1, further comprising:
sending a message to the mobile computing device, wherein the message indicates that the first transaction has been prohibited.

3. The computer-implemented method of claim 2, wherein the message requests authorization for the first transaction to proceed, the method further comprising:
receiving, from the mobile computing device, an authorization from the user to allow the first transaction to proceed; and
allowing, based on receiving the authorization, the first transaction to proceed.

4. The computer-implemented method of claim 2, wherein the message comprises one or more of:
an IP address associated with the first transaction; or
voice data associated with the first transaction.

5. The computer-implemented method of claim 1, further comprising:
receiving a third transaction that is associated with the account, wherein the third transaction is associated with a second user, wherein the second user is an authorized user of the account;
determining that the account is locked; and
based on determining that the account is locked and that the third transaction is associated with the second, authorized user, allowing the third transaction to proceed.

6. The computer-implemented method of claim 1, wherein the movement data comprises accelerometer data, and
wherein the movement data indicates a lack of movement by the user.

7. The computer-implemented method of claim 1, further comprising:
determining that a customer support request has been initiated for the account; and
based on the account being locked, prohibiting the customer support request.

8. The computer-implemented method of claim 1, wherein the indication that the user is asleep is based on historically-observed sleeping times of the user.

9. The computer-implemented method of claim 1, further comprising:
determining that a plurality of additional users are asleep; and
based on determining that the plurality of additional users are asleep, causing termination of one or more of:
a process executing on a second computing device, wherein the second computing device is associated with processing transactions associated with the plurality of additional users; or
a computing instance that is configured to process transactions associated with the plurality of additional users.

10. The computer-implemented method of claim 1, further comprising:
based on determining that the user is asleep, causing a change in appearance of an application via which the user accesses the account.

11. A computing device comprising:
one or more processors; and
memory storing instructions that, when executed by the one or more processors, cause the computing device to:
receive, from a mobile computing device, an indication that a user of the mobile computing device is asleep, wherein the indication that the user is asleep is based on movement data of a wearable computing device that is associated with the user;
lock, based on the indication that the user is asleep, an account of the user, wherein locking the account comprises restricting allowable actions that are associated with the account;
send, to the mobile computing device, an indication that the account has been locked;
receive an indication of a first transaction that is associated with the account of the user;
prohibit, based on the account being locked, the first transaction;
receive, from the mobile computing device, an indication that the user is awake;
unlock, based on the indication that the user is awake, the account of the user;
receive an indication of a second transaction; and
allow, based on the account being unlocked, the second transaction to proceed.

12. The computing device of claim 11, wherein the instructions, when executed by the one or more processors, cause the computing device to:
determine, based on data received from the mobile computing device, a confidence level that the user is asleep,
wherein locking the account of the user is based on the confidence level exceeding a threshold confidence level.

13. The computing device of claim 11, wherein the instructions, when executed by the one or more processors, cause the computing device to:
send a message to the mobile computing device, wherein the message indicates that the first transaction has been prohibited.

14. The computing device of claim 11, wherein the instructions, when executed by the one or more processors, cause the computing device to:
receive a third transaction that is associated with the account, wherein the third transaction comprises a card-not-present transaction;
determine that the account is locked; and
based on determining that the third transaction is a card-not-present transaction, allow the third transaction to proceed.

15. The computing device of claim 11, wherein the first transaction is prohibited based on the first transaction comprising a card-present transaction.

16. The computing device of claim 11, wherein the instructions, when executed by the one or more processors, cause the computing device to:
prohibit, based the account being locked, access to the account.

17. The computing device of claim 11, wherein the instructions, when executed by the one or more processors, cause the computing device to:
prohibit one or more customer support requests associated with the account.

18. A non-transitory computer readable medium comprising instructions, that when executed by one or more processors, cause a computing device to:
receive, from a mobile computing device, an indication that a user of the mobile computing device is asleep, wherein the indication that the user is asleep is based on movement data of a wearable computing device that is associated with the user;
lock, based on the indication that the user is asleep, an account of the user, wherein locking the account comprises restricting allowable actions that are associated with the account;
send, to the mobile computing device, an indication that the account has been locked;
receive an indication of a first transaction that is associated with the account of the user;
prohibit, based on the account being locked, the first transaction;
send a message to the mobile computing device, wherein the message indicates that the first transaction has been prohibited;
receive, from the mobile computing device, a request to unlock the account;
unlock, based on the request, the account;
receive an indication of a second transaction; and
allow, based on the account being unlocked, the second transaction to proceed.

19. The non-transitory computer readable medium of claim 18, wherein the instructions, when executed by the one or more processors, cause the computing device to:
receive, from the mobile computing device, proof that the user is awake,
wherein unlocking the account is based on the proof that the user is awake.

20. The non-transitory computer readable medium of claim 18, wherein the instructions, when executed by the one or more processors, cause the computing device to:
receive a third transaction that is associated with the account, wherein the third transaction comprises a recurring transaction;
determine that the account is locked; and
allow, based on determining that the third transaction is a recurring transaction, the third transaction to proceed.
